(19) United States
(12) Patent Application Publication
(10) Pub. No.: US 2024/0413496 A1
(43) Pub. Date: Dec. 12, 2024

(54) SECONDARY BATTERY AND METHOD OF MANUFACTURING SECONDARY BATTERY

(71) Applicant: Prime Planet Energy & Solutions, Inc., Tokyo (JP)

(72) Inventor: Naoya TADA, Himeji-shi (JP)

(21) Appl. No.: 18/673,315

(22) Filed: May 24, 2024

(30) Foreign Application Priority Data
Jun. 8, 2023 (JP) 2023-094758

(51) Int. Cl. H01M 50/548; H01M 10/04; H01M 50/103; H01M 50/186; H01M 50/538; H01M 50/553; H01M 50/655

(52) U.S. Cl. CPC H01M 50/548; H01M 10/0431; H01M 50/103; H01M 50/186; H01M 50/538; H01M 50/553; H01M 50/655

(57) ABSTRACT

This secondary battery includes: an electrode assembly including a first electrode and a second electrode having a polarity different from a polarity of the first electrode; and an exterior package that accommodates the electrode assembly and an electrolyte solution, wherein the exterior package includes a first wall and a second wall disposed to face each other, the first wall is provided with a first through hole and a first sealing member that seals the first through hole, the second wall is provided with a second through hole and a second sealing member that seals the second through hole, the first sealing member is different from the first electrode terminal and the second electrode terminal, and the second sealing member is different from the first electrode terminal and the second electrode terminal. This secondary battery can be manufactured efficiently and stably.

### CROSS REFERENCE TO RELATED APPLICATIONS

This nonprovisional application is based on Japanese Patent Application No. 2023-094758 filed on Jun. 8, 2023 with the Japan Patent Office, the entire contents of which are hereby incorporated by reference.

### BACKGROUND OF THE INVENTION

### Field of the Invention

The present technology relates to a secondary battery and a method of manufacturing the secondary battery.

### Description of the Background Art

Japanese Patent No. 4537353 discloses a prismatic secondary battery in which an electrode group (25) is accommodated in a battery case (14) provided with openings (14a, 14b) at both ends thereof and electrode terminals (21, 23) are respectively attached to cap plates (33, 33′) that seal the openings (14a, 14b).

### SUMMARY OF THE INVENTION

When a prismatic battery is configured such that a positive electrode terminal is provided on a side surface on one side and a negative electrode terminal is provided at an end portion on the other side in the battery case, a battery assembly can be likely to have a low height. However, there is room for further improvement in order to obtain a battery that has a higher volume energy density and that can be manufactured efficiently and stably. For example, it takes a time to impregnate a high-capacity, high-density electrode assembly with an electrolyte solution.

It is an object of the present technology to provide a secondary battery that can be efficiently and stably manufactured, and a method of manufacturing the secondary battery.

The present technology provides the following secondary battery and the following method of manufacturing the secondary battery.

[1] A secondary battery comprising: an electrode assembly including a first electrode and a second electrode having a polarity different from a polarity of the first electrode; an exterior package that accommodates the electrode assembly and an electrolyte solution; a first electrode terminal electrically connected to the first electrode and provided at the exterior package; and a second electrode terminal electrically connected to the second electrode and provided at the exterior package, wherein the exterior package includes a first wall and a second wall disposed to face each other, the first wall is provided with a first through hole and a first sealing member that seals the first through hole, the second wall is provided with a second through hole and a second sealing member that seals the second through hole, the first sealing member is different from the first electrode terminal and the second electrode terminal, and the second sealing member is different from the first electrode terminal and the second electrode terminal.

[2] The secondary battery according to [1], wherein the exterior package includes a case main body provided with a first opening at one end portion of the case main body and a second opening at the other end portion of the case main body, a first sealing plate that seals the first opening, and a second sealing plate that seals the second opening, the first wall is the first sealing plate, the second wall is the second sealing plate, the first sealing plate is provided with the first electrode terminal, the second sealing plate is provided with the second electrode terminal, the electrode assembly includes a first electrode tab group located at one end portion of the electrode assembly and including a plurality of first electrode tabs electrically connected to the first electrode, and a second electrode tab group located at the other end portion of the electrode assembly and including a plurality of second electrode tabs electrically connected to the second electrode, the first electrode tab group is electrically connected to the first electrode terminal, and the second electrode tab group is electrically connected to the second electrode terminal.

[3] The secondary battery according to [2], wherein the first electrode tab group is folded and joined to the first electrode terminal or a first electrode current collector member electrically connected to the first electrode terminal, and the second electrode tab group is folded and joined to the second electrode terminal or a second electrode current collector member electrically connected to the second electrode terminal.

[4] The secondary battery according to any one of [1] to [3], wherein in a long-side direction of the first wall, the first through hole is displaced to a side in a first direction with respect to a center of the first wall, and in a long-side direction of the second wall, the second through hole is displaced to a side in the first direction with respect to a center of the second wall.

[5] A method of manufacturing a secondary battery, the secondary battery comprising: an electrode assembly including a first electrode and a second electrode having a polarity different from a polarity of the first electrode; an exterior package that accommodates the electrode assembly and an electrolyte solution; a first electrode terminal electrically connected to the first electrode and provided at the exterior package; and a second electrode terminal electrically connected to the second electrode and provided at the exterior package, wherein the exterior package includes a first wall and a second wall disposed to face each other, the first wall is provided with a first through hole and a first sealing member that seals the first through hole, the second wall is provided with a second through hole and a second sealing member that seals the second through hole, the first sealing member is different from the first electrode terminal and the second electrode terminal, and the second sealing member is different from the first electrode terminal and the second electrode terminal, the method comprising: injecting an electrolyte solution into the exterior package from at least one of the first through hole and the second through hole; sealing the first through hole with the first sealing member; and sealing the second through hole with the second sealing member.

[6] The method of manufacturing the secondary battery according to [5], wherein in the injecting, the electrolyte solution is injected into the exterior package from one of the first through hole and the second through hole and a gas in the exterior package is discharged from the other of the first through hole and the second through hole to outside of the exterior package.

[7] The method of manufacturing the secondary battery according to [5] or [6],wherein the second electrode has a second electrode active material layer, in a direction that connects the first wall and the second wall, a relation of D2>D1 is satisfied, where D1 represents a distance between the first wall and an end portion of the second electrode active material layer on the first wall side, and D2 represents a distance between the second wall and an end portion of the second electrode active material layer on the second wall side, and the injecting includes injecting the electrolyte solution into the exterior package from the second through hole.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a secondary battery.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a front cross sectional view of the secondary battery shown in FIG. 1.

FIG. 6 is a front view showing a negative electrode raw plate before a negative electrode plate is formed.

FIG. 7 is a cross sectional view of the negative electrode raw plate shown in FIG. 6 along VII-VII.

FIG. 8 is a front view showing the negative electrode plate formed from the negative electrode raw plate.

FIG. 9 is a front view showing a positive electrode raw plate before a positive electrode plate is formed.

FIG. 10 is a cross sectional view of the positive electrode raw plate shown in FIG. 9 along X-X.

FIG. 11 is a front view showing the positive electrode plate formed from the positive electrode raw plate.

FIG. 12 is a diagram showing an electrode assembly and a current collector each removed from the secondary battery.

FIG. 13 is a diagram showing a connection structure between the negative electrode tab group and the negative electrode current collector.

FIG. 14 is a front view of the connection structure shown in FIG. 13.

FIG. 15 is a cross sectional view of the connection structure shown in FIG. 13.

FIG. 16 is a diagram showing a step of inserting the electrode assembly into a case main body.

FIG. 17 is a diagram showing a step of providing a spacer between the sealing plate and the electrode assembly.

FIG. 18 is a cross sectional view showing a state in which the spacer is provided between the sealing plate and the electrode assembly.

FIG. 19 is a diagram showing a modification of the spacer.

FIG. 20 is a diagram showing an exemplary mechanism that presses the electrode assembly with the sealing plate and the spacer being interposed therebetween.

FIG. 21 is a diagram showing a state in which the mechanism shown in FIG. 20 is viewed in the Z axis direction.

FIG. 22 is a perspective view of a spacer according to another embodiment.

FIG. 23 is a perspective view of a spacer according to another embodiment.

FIG. 24 is a perspective view of a spacer according to another embodiment.

FIG. 25 is a flowchart showing each step of a method of manufacturing the secondary battery.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium-ion battery. In the present specification, the term “electrode” may collectively represents a positive electrode and a negative electrode. Further, the term “electrode plate” may collectively represent a positive electrode plate and a negative electrode plate.

### (Overall Configuration of Battery)

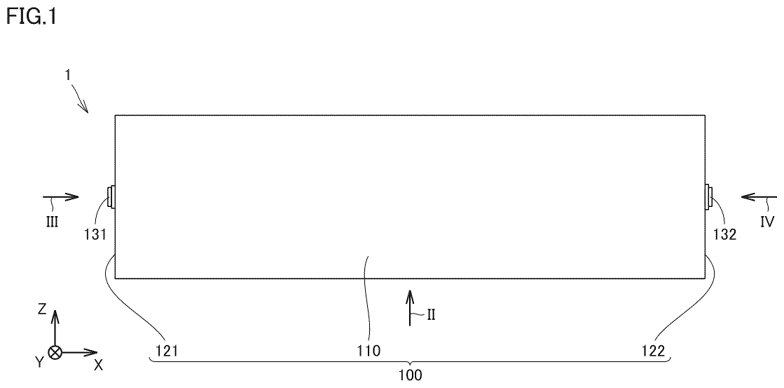

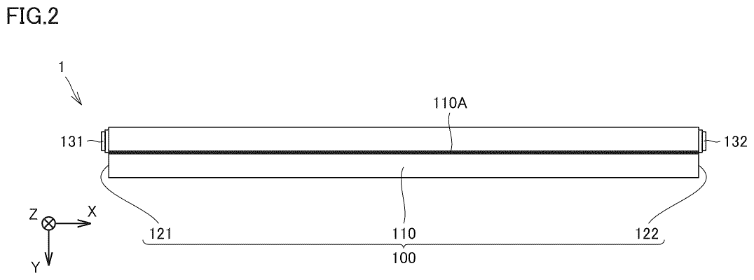

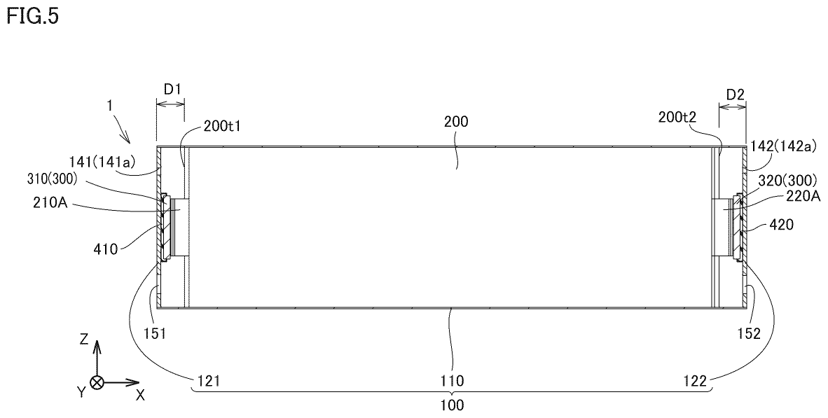

FIG. 1 is a front view of a secondary battery 1 according to the present embodiment. FIGS. 2 to 4 are diagrams showing states of secondary battery 1 shown in FIG. 1 when viewed in directions of arrows II, III, and IV, respectively. FIG. 5 is a front cross sectional view of secondary battery 1 shown in FIG. 1.

Secondary battery 1 can be mounted on a battery electric vehicle (BEV), a plug-in hybrid electric vehicle (PHEV), a hybrid electric vehicle (HEV), or the like. It should be noted that the purpose of use of secondary battery 1 is not limited to the use on a vehicle.

As shown in FIGS. 1 to 5, secondary battery 1 includes an exterior package 100, an electrode assembly 200, and current collectors 300. Exterior package 100 includes: a case main body 110; a first sealing plate 121 serving as a first wall; and a second sealing plate 122 serving as a second wall.

In the specification of the present application, an X axis direction (first direction) shown in FIGS. 1 to 5 may be referred to as a “width direction” of secondary battery 1 or case main body 110, a Y axis direction (second direction) may be referred to as a “thickness direction” of secondary battery 1 or case main body 110, and a Z direction (third direction) may be referred to as a “height direction” of secondary battery 1 or case main body 110. Further, in the description of the present disclosure, it is assumed that the Z axis direction coincides with a direction toward the top and bottom. Therefore, in secondary battery 1 shown in FIG. 1, the upper side in the figure is vertically upward and the lower side in the figure is vertically downward. Therefore, FIG. 2 shows a state when viewed from the bottom surface.

When forming a battery assembly including secondary battery 1, a plurality of secondary batteries 1 are stacked in the thickness direction of each of the plurality of secondary batteries 1. Secondary batteries 1 stacked may be restrained in the stacking direction (Y axis direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like.

As shown in FIGS. 1 and 2, first sealing plate 121 and second sealing plate 122 are provided at respective end portions of the case main body. Case main body 110 can be formed to have a prismatic tubular shape in, for example, the following manner: end sides of a plate-shaped member having been bent are brought into abutment with each other (joining portion 110A illustrated in FIG. 2) and are joined together (for example, laser welding). Each of the corners of the “prismatic tubular shape” may have a shape with a curvature.

In the present embodiment, the length of case main body 110 in the width direction (X axis direction) of secondary battery 1, i.e., in the direction (X axis direction) that connects first sealing plate 121 serving as the first wall and second sealing plate 122 serving as the second wall is longer than that in each of the thickness direction (Y axis direction) and the height direction (Z axis direction) of secondary battery 1.

The size (width) of case main body 110 in the X axis direction is preferably about 30 cm or more. In this way, secondary battery 1 can be formed to have a relatively large size (high capacity). The size (height) of case main body 110 in the Z axis direction is preferably about 20 cm or less, more preferably about 15 cm or less, and further preferably about 10 cm or less. Thus, (low-height) secondary battery 1 having a relatively low height can be formed, thus resulting in improved ease of mounting on a vehicle, for example.

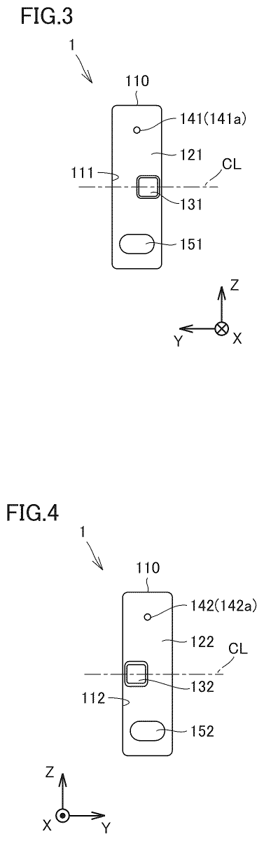

As shown in FIG. 3, a first opening 111 is provided at one end portion of case main body 110. First opening 111 is sealed with first sealing plate 121. First sealing plate 121 is provided with a negative electrode terminal 131 (first electrode terminal), a first through hole 141, and a gas-discharge valve 151. The positions of negative electrode terminal 131 and gas-discharge valve 151 can be appropriately changed. Each of first opening 111 and first sealing plate 121 has a substantially rectangular shape in which the Y axis direction corresponds to its short-side direction and the Z axis direction corresponds to its long-side direction. In the long-side direction (Z direction) of first sealing plate 121, first through hole 141 is displaced to a side in the first direction (upper side in the figure) with respect to center CL of first sealing plate 121. First through hole 141 is sealed with a first sealing member 141a.

As shown in FIG. 4, a second opening 112 is provided at one end portion of case main body 110. Second opening 112 is sealed with second sealing plate 122. Second sealing plate 122 is provided with a positive electrode terminal 132 (second electrode terminal), a second through hole 142, and a gas-discharge valve 152. The positions of positive electrode terminal 132 and gas-discharge valve 152 can be appropriately changed. Each of second opening 112 and second sealing plate 122 has a substantially rectangular shape in which the Y axis direction corresponds to its short-side direction and the Z axis direction corresponds to its long-side direction. In the long-side direction (Z direction) of second sealing plate 122, second through hole 142 is displaced to a side in the first direction (upper side in the figure) with respect to center CL of second sealing plate 122. Second through hole 142 is sealed with a second sealing member 142a.

Each of first sealing member 141a and second sealing member 142a can be swaged and fixed to case main body 110 by using a blind rivet or another metal member, for example. Each of first sealing member 141a and second sealing member 142a may be fixed to case main body 110 by welding.

Each of first sealing plate 121 and second sealing plate 122 is composed of a metal. Specifically, each of first sealing plate 121 and second sealing plate 122 is composed of aluminum, an aluminum alloy, iron, an iron alloy, or the like.

Negative electrode terminal 131 is electrically connected to a negative electrode of electrode assembly 200. Positive electrode terminal 132 is electrically connected to a positive electrode of electrode assembly 200.

Negative electrode terminal 131 is composed of a conductive material (more specifically, a metal), and can be composed of copper, a copper alloy, or the like, for example. A portion or layer composed of aluminum or an aluminum alloy may be provided at a portion of an outer surface of negative electrode terminal 131.

Positive electrode terminal 132 is composed of a conductive material (more specifically, a metal), and can be composed of aluminum, an aluminum alloy, or the like, for example.

First through hole 141 and first sealing member 141a are different from negative electrode terminal 131 as shown in the figure, and first sealing member 141a does not function as negative electrode terminal 131. Therefore, first sealing member 141a preferably does not have a polarity as negative electrode terminal 131. Further, first sealing plate 121 also preferably does not have a polarity as negative electrode terminal 131. For example, a resin sealing portion, a rubber portion, or the like may be interposed between first sealing plate 121 and case main body 110.

Similarly, second through hole 142 and second sealing member 142a are different from positive electrode terminal 132 as shown in the figure, and second sealing member 142a does not function as positive electrode terminal 132. Therefore, second sealing member 142a preferably does not have a polarity as positive electrode terminal 132. Further, second sealing plate 122 also preferably does not have a polarity as positive electrode terminal 132. For example, a resin sealing portion, a rubber portion, or the like may be interposed between second sealing plate 122 and case main body 110.

It should be noted that exterior package 100 may be electrically connected to negative electrode plate 210 or positive electrode plate 220. In this case, each of first sealing member 141a and second sealing member 142a may have one of the polarities; however, even in this case, each of first sealing member 141a and second sealing member 142a is not used as a terminal and a terminal is separately provided. Hence, first sealing member 141a is different from negative electrode terminal 131 and positive electrode terminal 132, and second sealing member 142a is different from positive electrode terminal 132 and negative electrode terminal 131.

Each of gas-discharge valves 151, 152 is fractured to discharge a gas in exterior package 100 to outside when pressure in exterior package 100 becomes equal to or more than a predetermined value.

Electrode assembly 200 is an electrode assembly having a flat shape and having a below-described positive electrode plate and a below-described negative electrode plate. Specifically, electrode assembly 200 is a wound type electrode assembly in which a strip-shaped positive electrode plate and a strip-shaped negative electrode plate are both wound with a strip-shaped separator (not shown) being interposed therebetween. It should be noted that in the present specification, the “electrode assembly” is not limited to the wound type electrode assembly, and may be a stacked type electrode assembly in which a plurality of positive electrode plates and a plurality of negative electrode plates are alternately stacked. The electrode assembly may include a plurality of positive electrode plates and a plurality of negative electrode plates, respective positive electrode tabs provided in the positive electrode plates may be stacked to form a positive electrode tab group, and respective negative electrode tabs provided in the negative electrode plates may be stacked to form a negative electrode tab group.

As described below in “Manufacturing Process for Secondary Battery 1”, when first through hole 141 is used as an injection hole for electrolyte solution, second through hole 142 functions as a gas (air) discharge hole in case main body 110. On the other hand, when second through hole 142 is used as an injection hole for electrolyte solution, first through hole 141 functions as a discharge hole for gas (air) in case main body 110.

As shown in FIG. 5, exterior package 100 accommodates electrode assembly 200. Electrode assembly 200 is accommodated in exterior package 100 such that the winding axis thereof is parallel to the X axis direction.

Specifically, one or a plurality of the wound type electrode assemblies and the electrolyte solution (electrolyte) (not shown) are accommodated inside a below-described insulating sheet 600 disposed in exterior package 100 and serving as a separator. As the electrolyte solution (non-aqueous electrolyte solution), it is possible to use, for example, a solution obtained by dissolving LiPF₆ at a concentration of 1.2 mol/L in a non-aqueous solvent obtained by mixing ethylene carbonate (EC), ethyl methyl carbonate (EMC), and diethyl carbonate (DEC) at a volume ratio (25° C.) of 30:30:40. It should be noted that instead of the electrolyte solution, a solid electrolyte may be used.

Electrode assembly 200 includes: a negative electrode tab group 210A (first electrode tab group) provided at an end portion (first end portion) thereof on the first sealing plate 121 side; and a positive electrode tab group 220A (second electrode tab group) provided at an end portion (second end portion) thereof on the second sealing plate 122 side. Negative electrode tab group 210A and positive electrode tab group 220A are connected to the negative electrode and positive electrode of electrode assembly 200, respectively. Negative electrode tab group 210A and positive electrode tab group 220A are formed to protrude toward first sealing plate 121 and second sealing plate 122 respectively from a main body portion (a portion in which the positive electrode plate and the negative electrode plate are stacked with a separator being interposed therebetween) of electrode assembly 200.

Current collectors 300 include a negative electrode current collector 310 (first current collector) and a positive electrode current collector 320 (second current collector). Each of negative electrode current collector 310 and positive electrode current collector 320 is constituted of a plate-shaped member. Electrode assembly 200 is electrically connected to negative electrode terminal 131 and positive electrode terminal 132 through current collectors 300.

Negative electrode current collector 310 is disposed on first sealing plate 121 with an insulating member composed of a resin being interposed therebetween. Negative electrode current collector 310 is electrically connected to negative electrode tab group 210A and negative electrode terminal 131. Negative electrode current collector 310 is composed of a conductive material (more specifically, a metal), and can be composed of copper, a copper alloy, or the like, for example.

Positive electrode current collector 320 is disposed on second sealing plate 122 with an insulating member composed of a resin being interposed therebetween. Positive electrode current collector 320 is electrically connected to positive electrode tab group 220A and positive electrode terminal 132. Positive electrode current collector 320 is composed of a conductive material (more specifically, a metal), and can be composed of aluminum, an aluminum alloy, or the like, for example. It should be noted that positive electrode tab group 220A may be electrically connected to second sealing plate 122 directly or via positive electrode current collector 320. In this case, second sealing plate 122 may serve as positive electrode terminal 123.

A relation of D2>D1 is satisfied, where D1 represents a distance between first sealing plate 121 and an end portion 200t1 of electrode assembly 200 on the first sealing plate 121 side, and D2 represents a distance between second sealing plate 122 and an end portion 200t2 of electrode assembly 200 on the second sealing plate 122 side. Preferably, D1/D2>1.2 is satisfied, and more preferably D1/D2>1.5 is satisfied. Here, end portion 200t1 of electrode assembly 200 on the first sealing plate 121 side is an end portion of a below-described positive electrode active material layer 222, and similarly, end portion 200t2 of electrode assembly 200 on the second sealing plate 122 side is an end portion of positive electrode active material layer 222.

Thus, a space between electrode assembly 200 and second sealing plate 122 is larger than a space between electrode assembly 200 and first sealing plate 121. Therefore, second through hole 142 is preferably used as the injection hole for electrolyte solution. Therefore, first through hole 141 located on the first sealing plate 121 side is preferably used as a discharge hole for gas (air) in case main body 110.

### (Configuration of Electrode Assembly 200)

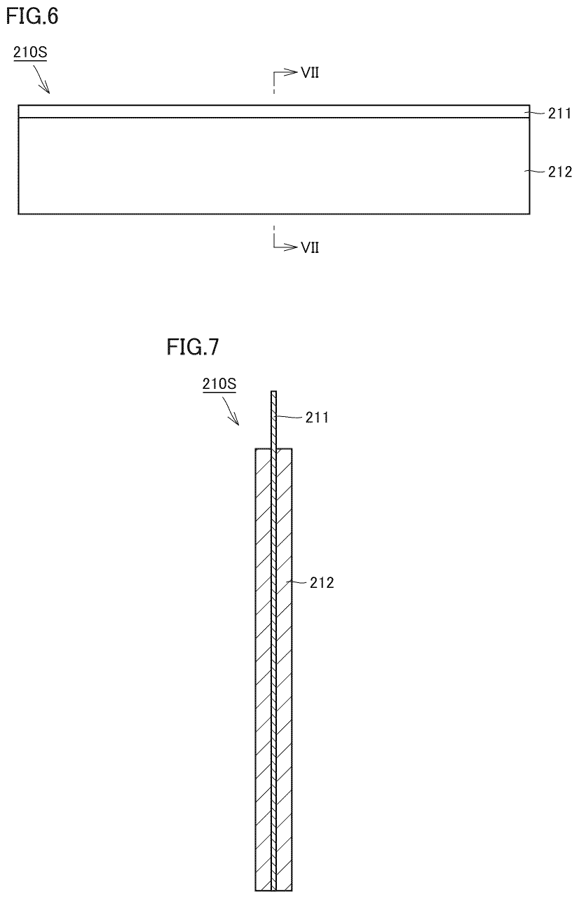

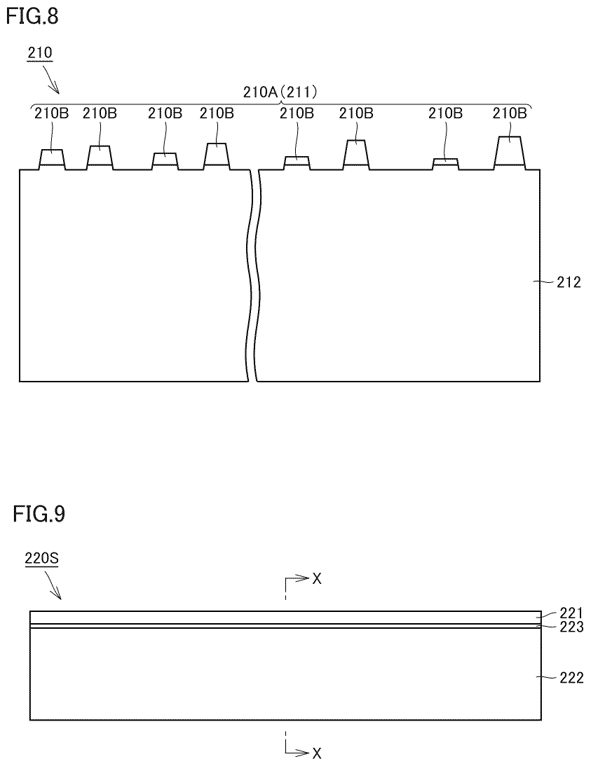

FIG. 6 is a front view showing a negative electrode raw plate 210S before negative electrode plate 210 (first electrode) is formed, FIG. 7 is a cross sectional view of negative electrode raw plate 210S shown in FIG. 6 along VII-VII, and FIG. 8 is a front view showing negative electrode plate 210 formed from negative electrode raw plate 210S.

Negative electrode plate 210 is manufactured by processing negative electrode raw plate 210S. As shown in FIGS. 6 and 7, negative electrode raw plate 210S includes a negative electrode core body 211 and a negative electrode active material layer 212. Negative electrode core body 211 is a copper foil or a copper alloy foil.

Negative electrode active material layer 212 is formed on negative electrode core body 211 except for each of end portions of both surfaces of negative electrode core body 211 on one side. Negative electrode active material layer 212 is formed by applying a negative electrode active material layer slurry using a die coater.

The negative electrode active material layer slurry is produced by kneading graphite serving as a negative electrode active material, styrene-butadiene rubber (SBR) and carboxymethyl cellulose (CMC) each serving as a binder, and water serving as a dispersion medium such that the mass ratio of the graphite, the SBR, and the CMC is about 98:1:1.

Negative electrode core body 211 having the negative electrode active material layer slurry applied thereon is dried to remove the water included in the negative electrode active material layer slurry, thereby forming negative electrode active material layer 212. Further, by compressing negative electrode active material layer 212, negative electrode raw plate 210S including negative electrode core body 211 and negative electrode active material layer 212 is formed. Negative electrode raw plate 210S is cut into a predetermined shape, thereby forming negative electrode plate 210. Negative electrode raw plate 210S can be cut by laser processing with application of an energy ray, die processing, cutter processing, or the like.

As shown in FIG. 8, a plurality of negative electrode tabs 210B each constituted of negative electrode core body 211 are provided at one end portion, in the width direction, of negative electrode plate 210 formed from negative electrode raw plate 210S. When negative electrode plate 210 is wound, the plurality of negative electrode tabs 210B are stacked to form negative electrode tab group 210A. The position of each of the plurality of negative electrode tabs 210B and the length thereof in the protruding direction are appropriately adjusted in consideration of the state in which negative electrode tab group 210A is connected to negative electrode current collector 310. It should be noted that the shape of negative electrode tab 210B is not limited to the one illustrated in FIG. 8.

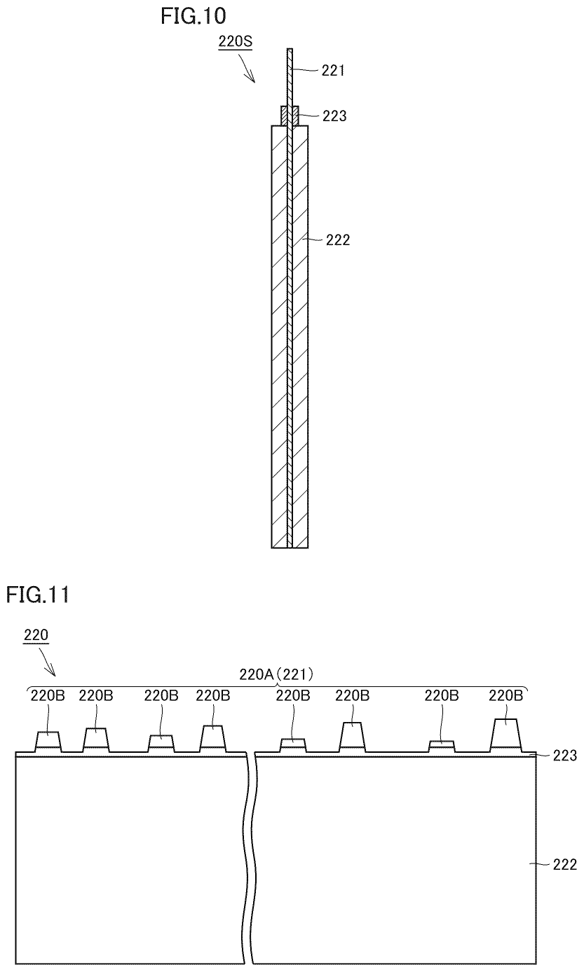

FIG. 9 is a front view showing a positive electrode raw plate 220S before positive electrode plate 220 (second electrode) is formed, FIG. 10 is a cross sectional view of positive electrode raw plate 220S shown in FIG. 9 along X-X, and FIG. 11 is a front view showing positive electrode plate 220 formed from positive electrode raw plate 220S.

Positive electrode plate 220 is manufactured by processing positive electrode raw plate 220S. As shown in FIGS. 9 and 10, positive electrode raw plate 220S includes a positive electrode core body 221, a positive electrode active material layer 222, and a positive electrode protective layer 223. Positive electrode core body 221 is an aluminum foil or an aluminum alloy foil.

Positive electrode active material layer 222 is formed on positive electrode core body 221 except for each of end portions of both surfaces of positive electrode core body 221 on one side. Positive electrode active material layer 222 is formed on positive electrode core body 221 by applying a positive electrode active material layer slurry using a die coater.

The positive electrode active material layer slurry is produced by kneading a lithium-nickel-cobalt-manganese composite oxide serving as a positive electrode active material, polyvinylidene difluoride (PVdF) serving as a binder, a carbon material serving as a conductive material, and N-methyl-2-pyrrolidone (NMP) serving as a dispersion medium such that the mass ratio of the lithium-nickel-cobalt-manganese composite oxide, the PVdF, and the carbon material is about 97.5:1:1.5.

Positive electrode protective layer 223 is formed in contact with positive electrode core body 221 at an end portion of positive electrode active material layer 222 on the one side in the width direction. Positive electrode protective layer 223 is formed on positive electrode core body 221 by applying a positive electrode protective layer slurry using a die coater. Positive electrode protective layer 223 has an electrical resistance larger than that of positive electrode active material layer 222.

The positive electrode protective layer slurry is produced by kneading alumina powder, a carbon material serving as a conductive material, PVdF serving as a binder, and NMP serving as a dispersion medium such that the mass ratio of the alumina powder, the carbon material, and the PVdF is about 83:3:14.

Positive electrode core body 221 having the positive electrode active material layer slurry and the positive electrode protective layer slurry applied thereon is dried to remove the NMP included in the positive electrode active material layer slurry and the positive electrode protective layer slurry, thereby forming positive electrode active material layer 222 and positive electrode protective layer 223. Further, by compressing positive electrode active material layer 222, positive electrode raw plate 220S including positive electrode core body 221, positive electrode active material layer 222, and positive electrode protective layer 223 is formed. Positive electrode raw plate 220S is cut into a predetermined shape, thereby forming positive electrode plate 220. Positive electrode raw plate 220S can be cut by laser processing with application of an energy ray, die processing, cutter processing, or the like.

As shown in FIG. 11, a plurality of positive electrode tabs 220B each constituted of positive electrode core body 221 are provided at one end portion, in the width direction, of positive electrode plate 220 formed from positive electrode raw plate 220S. When positive electrode plate 220 is wound, the plurality of positive electrode tabs 220B are stacked to form positive electrode tab group 220A. The position of each of the plurality of positive electrode tabs 220B and the length thereof in the protruding direction are appropriately adjusted in consideration of the state in which positive electrode tab group 220A is connected to positive electrode current collector 320. It should be noted that the shape of positive electrode tab 220B is not limited to the one illustrated in FIG. 11.

Positive electrode protective layer 223 is provided at the root of each of the plurality of positive electrode tabs 220B. Positive electrode protective layer 223 may not necessarily be provided at the root of positive electrode tab 220B. It should be noted that the thickness of positive electrode protective layer 223 is preferably smaller than the thickness of positive electrode active material layer 222.

In a typical example, the thickness of (one) negative electrode tab 210B is smaller than the thickness of (one) positive electrode tab 220B. In this case, the thickness of negative electrode tab group 210A is smaller than the thickness of positive electrode tab group 220A.

### (Connection Structure Between Electrode Assembly 200 and Current Collector 300)

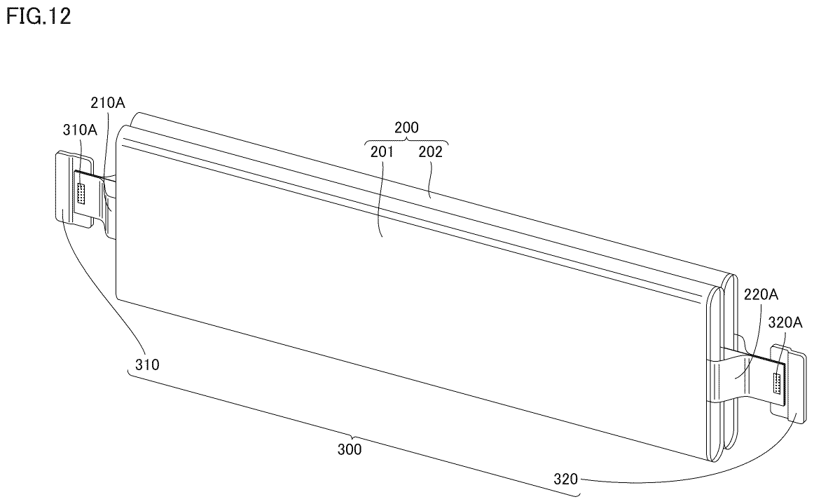

FIG. 12 is a diagram showing electrode assembly 200 and current collector 300 each removed from secondary battery 1. As shown in FIG. 12, electrode assembly 200 is formed by stacking two electrode assemblies 201, 202, each of which is a wound type electrode assembly. Although FIG. 12 illustratively shows the structure in which two wound type electrode assemblies are stacked, electrode assembly 200 may be constituted of one wound type electrode assembly, may be constituted of three or more wound type electrode assemblies, or may be constituted of a stacked type electrode assembly.

Negative electrode tab group 210A is joined to negative electrode current collector 310 at a joining portion 310A and positive electrode tab group 220A is joined to positive electrode current collector 320 at a joining portion 320A. Each of joining portions 310A, 320A can be formed by, for example, ultrasonic bonding, resistance welding, laser welding, swaging, or the like.

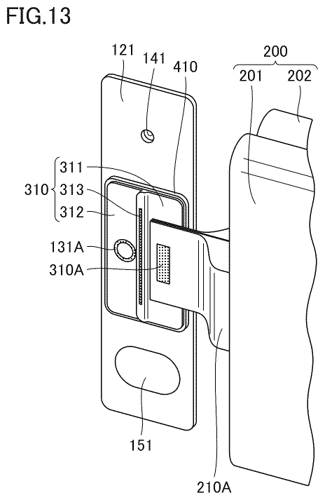

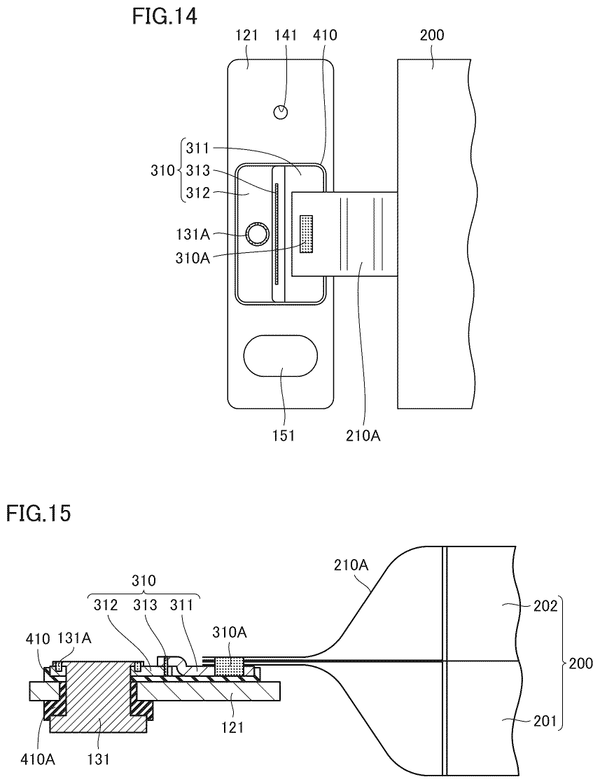

FIG. 13 is a diagram showing a connection structure between negative electrode tab group 210A and negative electrode current collector 310. FIGS. 14 and 15 are respectively a front view and a cross sectional view of the connection structure shown in FIG. 13.

As shown in FIGS. 13 to 15, negative electrode current collector 310 is connected to negative electrode terminal 131 between electrode assembly 200 and first sealing plate 121. Negative electrode current collector 310 includes a first conductive member 311 and a second conductive member 312. First conductive member 311 and second conductive member 312 are joined to each other at a joining portion 313.

Negative electrode tab group 210A is joined to first conductive member 311 of negative electrode current collector 310 at joining portion 310A. First conductive member 311 is connected to second conductive member 312 at joining portion 313. Joining portion 313 can be formed by, for example, ultrasonic bonding, resistance welding, laser welding, swaging, or the like.

Each of first conductive member 311 and second conductive member 312 is attached to the inner surface side of first sealing plate 121 with an insulating member 410 composed of a resin being interposed therebetween.

Negative electrode terminal 131 is attached to first sealing plate 121 with an insulating member 410A composed of a resin being interposed therebetween. Negative electrode terminal 131 is provided to be exposed to the outside of first sealing plate 121 and reach second conductive member 312 of negative electrode current collector 310 provided on the inner surface side of first sealing plate 121. Negative electrode terminal 131 and second conductive member 312 can be connected by ultrasonic bonding, resistance welding, laser welding, swaging, or the like, for example. In the present embodiment, negative electrode terminal 131 and second conductive member 312 are connected in the following manner: a through hole is provided in second conductive member 312, negative electrode terminal 131 is inserted into the through hole, negative electrode terminal 131 is swaged on second conductive member 312, and then the swaged portion and second conductive member 312 are welded at a joining portion 131A.

As a procedure for assembling each component, first, negative electrode terminal 131 and second conductive member 312 as well as insulating members 410, 410A are attached to first sealing plate 121. Next, first conductive member 311 connected to electrode assembly 200 is attached to second conductive member 312. On this occasion, first conductive member 311 is disposed on first insulating member 410 such that a portion of first conductive member 311 overlaps with second conductive member 312. Next, first conductive member 311 and second conductive member 312 are welded and connected to each other at joining portion 313. It should be noted that insulating members 410, 410A may be constituted of one member.

It should be noted that negative electrode terminal 131 may be electrically connected to first sealing plate 121. Further, first sealing plate 121 may serve as negative electrode terminal 131.

It should be noted that each of FIGS. 13 to 15 illustrates negative electrode current collector 310 constituted of two components (first conductive member 311 and second conductive member 312); however, negative electrode current collector 310 may be constituted of one component.

Each of FIGS. 13 to 15 shows the connection structure on the negative electrode side; however, the basic connection structure on the positive electrode side is the same as that on the negative electrode side.

### (Step of Inserting Electrode Assembly 200)

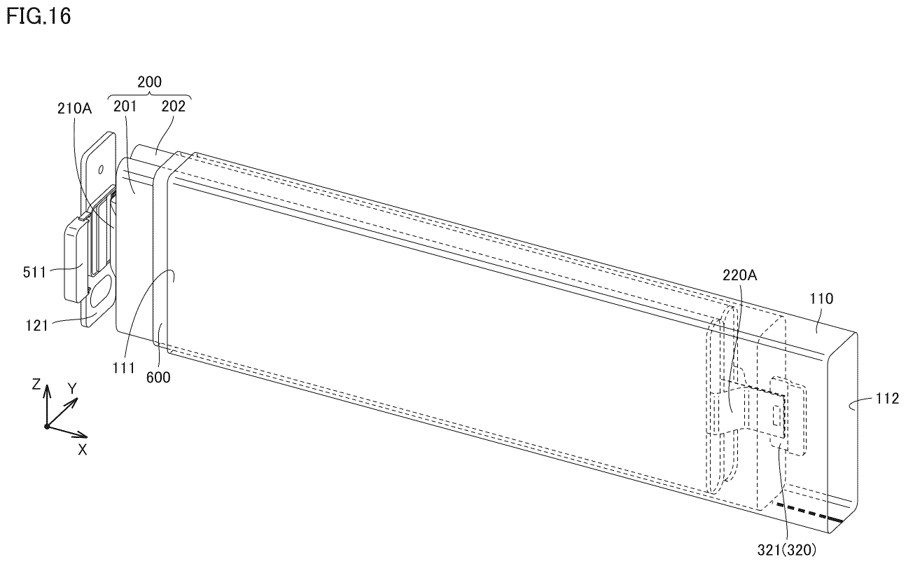

FIG. 16 is a diagram showing a step of inserting electrode assembly 200 into case main body 110. As shown in FIG. 16, insulating sheet 600 (electrode assembly holder) composed of a resin is disposed between electrode assembly 200 and case main body 110.

Insulating sheet 600 may be composed of, for example, a resin. More specifically, the material of insulating sheet 600 is, for example, polypropylene (PP), polyethylene terephthalate (PET), polyphenylene sulfide (PPS), polyimide (PI), or polyolefin (PO).

Insulating sheet 600 does not necessarily need to cover a whole of the surfaces of electrode assembly 200. Insulating sheet 600 preferably covers an area of about 50% or more, more preferably about 70% or more, of the outer surfaces of the electrode assembly. Insulating sheet 600 preferably covers a whole of at least four surfaces of the six surfaces of electrode assembly 200 having a substantially rectangular parallelepiped shape (flat shape) other than the two surfaces thereof on which negative electrode tab group 210A and positive electrode tab group 220A are formed respectively.

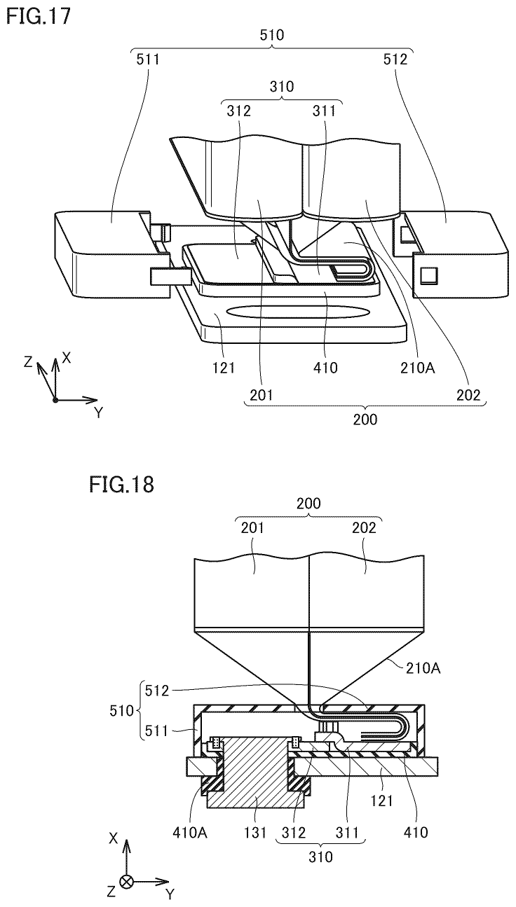

FIG. 17 is a diagram showing a step of disposing a spacer 510 between first sealing plate 121 and electrode assembly 200. FIG. 18 is a cross sectional view showing a state in which spacer 510 is disposed between first sealing plate 121 and electrode assembly 200.

As shown in FIGS. 17 and 18, negative electrode tab group 210A extends from electrode assembly 200 toward first sealing plate 121 in the following manner: negative electrode tab group 210A extends from the central portion of first sealing plate 121 to an end portion of first sealing plate 121 in the Y axis direction and is then bent to be folded back toward the central portion in an opposite direction. Spacer 510 is provided to store the bent negative electrode tab group 210A (bent portion).

Spacer 510 includes a first spacer 511 and a second spacer 512. First spacer 511 and second spacer 512 are slid along the Y axis direction from the respective end portion sides to the center side of first sealing plate 121, and are accordingly engaged with each other. Thus, spacer 510 is fixed to first sealing plate 121 with insulating member 410 being interposed therebetween, thereby increasing stability of the position of spacer 510.

As shown in FIG. 18, spacer 510 forms an inner space for accommodating negative electrode current collector 310, and the tip portion of negative electrode tab group 210A is also accommodated in the inner space of spacer 510. Spacer 510 is provided with a hole portion through which negative electrode tab group 210A passes.

The material of spacer 510 is not particularly limited, but an insulating material such as a resin is preferably used. More specifically, it is preferable to use a sheet composed of polyolefin (PO). Further, insulating sheet 600 may be interposed between spacer 510 and electrode assembly 200.

Referring again to FIG. 16, in a method of manufacturing secondary battery 1 according to the present embodiment, after negative electrode terminal 131 and negative electrode tab group 210A are electrically connected to each other, electrode assembly 200 is inserted into case main body 110 through first opening 111 from its end portion side on the positive electrode tab group 220A side. When electrode assembly 200 is inserted to a predetermined position of case main body 110, positive electrode tab group 220A protrudes to the outside of case main body 110 with respect to second opening 112 of case main body 110. Thus, after electrode assembly 200 is inserted into case main body 110, positive electrode terminal 132 and positive electrode tab group 220A can be connected to each other.

When negative electrode terminal 131 attached to first sealing plate 121 is electrically connected to negative electrode tab group 210A after electrode assembly 200 is inserted into case main body 110, negative electrode tab group 210A is required to have such a length that negative electrode tab group 210A of electrode assembly 200 accommodated in case main body 110 sufficiently protrudes to the outside of case main body 110. By electrically connecting negative electrode terminal 131, which is attached to first sealing plate 121, and negative electrode tab group 210A before electrode assembly 200 is inserted into case main body 110, the length of negative electrode tab group 210A can be reduced as compared with a case where negative electrode terminal 131 is attached to negative electrode tab group 210A after electrode assembly 200 is inserted into case main body 110. As a result, a volume occupation ratio of negative electrode plate 210 and positive electrode plate 220 in the inner space of case main body 110 can be increased.

In the example of FIG. 16, electrode assembly 200 is inserted into case main body 110 after spacer 510 that accommodates the bent portion of negative electrode tab group 210A is disposed. In this way, the bent portion of negative electrode tab group 210A can be protected in the step of inserting electrode assembly 200.

In the example of FIG. 16, electrode assembly 200 is inserted in case main body 110 with electrode assembly 200 being covered with insulating sheet 600. Thus, electrode assembly 200 can be suppressed from being damaged at the time of insertion into case main body 110.

Case main body 110 can be held at a predetermined angle during the step of inserting electrode assembly 200. As an example, electrode assembly 200 is preferably inserted with case main body 110 being held such that the X axis direction (width direction of case main body 110) intersects the horizontal direction at an angle of about ±45° or less. For example, electrode assembly 200 can be inserted into case main body 110 with case main body 110 being inclined such that the upper end portion of first opening 111 into which electrode assembly 200 is to be inserted is located above the upper end portion of second opening 112 in the vertical direction.

The step of inserting electrode assembly 200 is not limited to pushing electrode assembly 200 from the first opening 111 side, and may be performed by, for example, pulling electrode assembly 200 from the second opening 112 side.

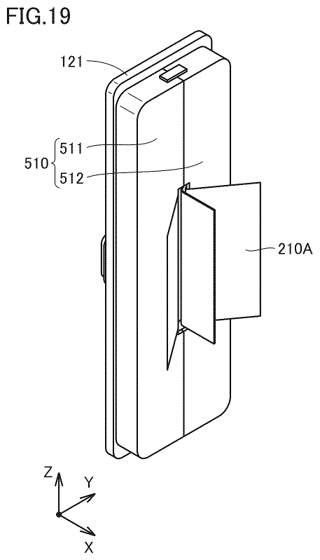

FIG. 19 is a diagram showing a modification of spacer 510. In the example of FIGS. 16 to 18, spacer 510 is disposed at a portion of first sealing plate 121 in the height direction (Z axis direction); however, spacer 510 is disposed at substantially a whole of first sealing plate 121 in the height direction as shown in FIG. 19. On this occasion, spacer 510 may have a portion that is located at a position (first region) separated from negative electrode tab group 210A in the Z axis direction and that protrudes to the electrode assembly 200 side with respect to a vicinity (second region) of negative electrode tab group 210A. A step (preferably, a step of about 1 mm or more) may be formed at a boundary between the first region and the second region. Thus, negative electrode tab group 210A can be suppressed from being damaged when inserting electrode assembly 200 into case main body 110.

### (Mechanism That Presses Electrode Assembly)

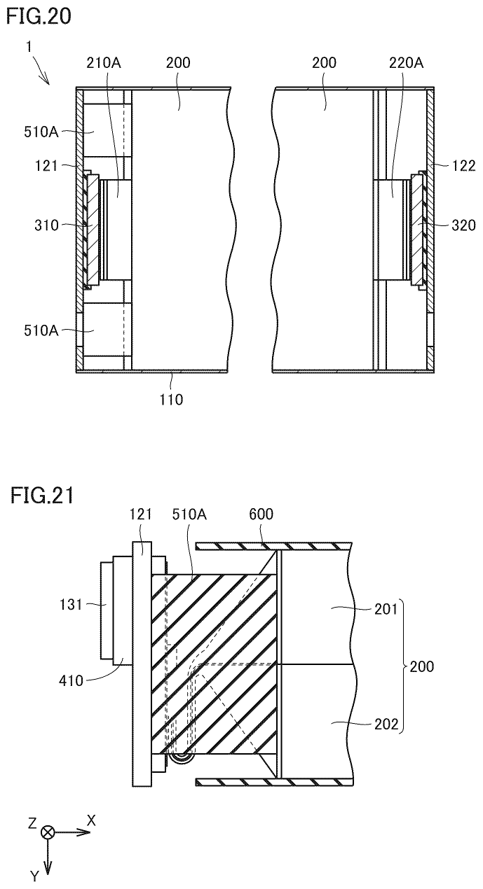

FIG. 20 is a diagram showing an exemplary mechanism that presses electrode assembly 200 with first sealing plate 121 and a spacer 510A being interposed therebetween. FIG. 21 is a diagram showing a state in which the mechanism shown in FIG. 20 is viewed in the Z axis direction. Spacer 510A is a modification of spacer 510 described above.

As shown in FIGS. 20 and 21, spacer 510A is disposed at a position to avoid negative electrode tab group 210A and negative electrode current collector 310 (position separated from negative electrode tab group 210A and negative electrode current collector 310) in the height direction (Z axis direction) of each of first sealing plate 121 and electrode assembly 200. More specifically, spacer 510A is disposed at two locations so as to sandwich negative electrode tab group 210A in the Z axis direction. Spacer 510A preferably presses a portion of electrode assembly 200 at which negative electrode tab group 210A is not provided. In particular, spacer 510A preferably presses its portion at which the separator protrudes with respect to the end portion of negative electrode plate 210. Spacer 510A may be provided only on one side of negative electrode tab group 210A in the Z axis direction. Spacer 510A can be fixed to first sealing plate 121 and/or electrode assembly 200 by, for example, adhesion, welding, taping, or the like. It should be noted that spacer 510A may be in contact with negative electrode tab group 210A.

It is preferable to provide a through hole, a notch, a slit, or the like in spacer 510A at a position facing first through hole 141. Further, it is preferable to provide a through hole, a notch, a slit, or the like in spacer 510A at a position facing gas-discharge valve 151. Thus, the function of first through hole 141 or gas-discharge valve 151 can be ensured more securely.

In the example of FIGS. 20 and 21, electrode assembly 200 is inserted into case main body 110 by pressing electrode assembly 200 with spacer 510A being interposed therebetween. In an initial stage of the step of inserting electrode assembly 200, a portion of electrode assembly 200 may be inserted into case main body 110 with electrode assembly 200 being held and spacer 510A being not in abutment with electrode assembly 200, and then electrode assembly 200 may be further inserted by pressing electrode assembly 200 with spacer 510A being interposed therebetween.

Instead of the spacer described above, a spacer fixed to electrode assembly 200 may be provided. The fixation of the spacer to electrode assembly 200 is performed by, for example, taping or the like.

It should be noted that in order to protect positive electrode tab group 220A, each of spacer 510 and spacer 510A may be provided on the positive electrode tab group 220A side. Also in the spacer disposed on the positive electrode tab group 220A side, an opening through which the electrolyte solution passes is preferably provided at a position facing second through hole 142. The shape of the opening may be any shape as long as the electrolyte solution passes therethrough.

When the thicknesses of the spacer disposed on the negative electrode tab group 210A side and the thickness of the spacer disposed on the positive electrode tab group 220A side (thicknesses in the direction (X axis direction) that connects first sealing plate 121 and second sealing plate 122) are compared, a space between electrode assembly 200 and second sealing plate 122 is larger than a space between electrode assembly 200 and first sealing plate 121. Therefore, the thickness of the spacer disposed on the positive electrode tab group 220A side is preferably larger than the thickness of the spacer disposed on the negative electrode tab group 210A side.

Referring again to FIGS. 17 and 18, negative electrode tab group 210A is folded and connected to negative electrode current collector 310, and negative electrode terminal 131 is connected to negative electrode current collector 310. Similarly, positive electrode tab group 220A is folded and connected to positive electrode current collector 320, and positive electrode terminal 132 is connected to positive electrode current collector 320 (see FIG. 20). A joining surface between negative electrode tab group 210A and negative electrode current collector 310 is preferably disposed along and parallel to first sealing plate 121, but may not necessarily be parallel. For example, the joining surface is preferably disposed within a range of ±30°. Similarly, a joining surface between positive electrode tab group 220A and positive electrode current collector 320 is preferably disposed along and parallel to second sealing plate 122, but may not necessarily be parallel. For example, the joining surface is preferably disposed within a range of ±30°.

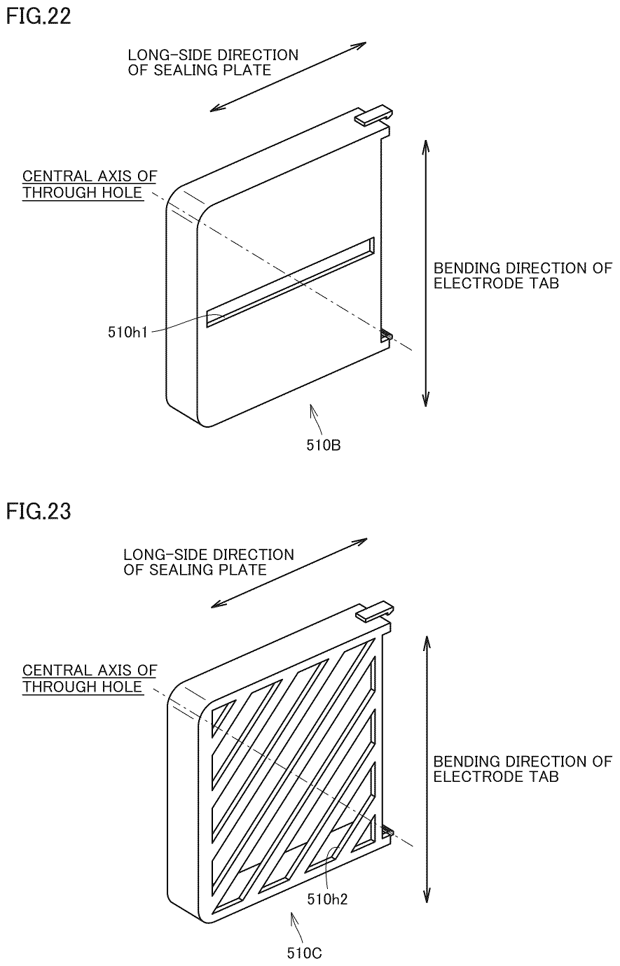

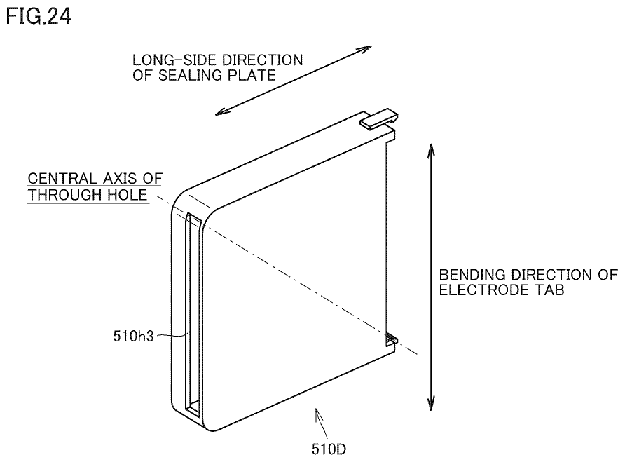

Here, referring to FIGS. 22 to 24, spacers according to other embodiments will be illustrated. FIG. 22 is a perspective view of a spacer 510B according to another embodiment, FIG. 23 is a perspective view of a spacer 510C according to another embodiment, and FIG. 24 is a perspective view of a spacer 510D according to another embodiment. The spacers described below can be disposed on both the negative electrode tab group 210A side and the positive electrode tab group 220A side.

In spacer 510B shown in FIG. 22, an opening 510h1 having a rectangular shape is provided on the side facing electrode assembly 200. In the case of spacer 510B, an opening 510h1 is located at a position facing first through hole 141 (or second through hole 142).

In spacer 510C shown in FIG. 23, openings 510h2 each having a shape of oblique slit are provided on the side facing electrode assembly 200. When openings 510h2 each having such a shape of slit are provided, a sufficient opening area can be secured, a flow path area necessary for degassing and liquid injection can be secured, and the injected solvent is less likely to be accumulated, advantageously.

In spacer 510D shown in FIG. 24, an opening 510h3 having a rectangular shape is provided on a position not facing first through hole 141 (or second through hole 142). Opening 510h3 is disposed at a position perpendicular to the bending direction of the electrode tab. As a result, it is possible to prevent curling-up of the separator and damage of the electrode (including the tab) due to momentum of the injection, is possible to attain uniform pressing at the time of insertion of the electrode assembly, and is possible to prevent the bent electrode tab from protruding from the space in the spacer.

The outer shape of the spacer and the position and shape of the opening are not limited to those of the spacer described above; however, by appropriately providing the opening in the spacer to be disposed to protect each of negative electrode tab group 210A and positive electrode tab group 220A, it is possible to achieve suppression of damage of the electrode assembly or suppression of unintended short circuit, and suppression of decreased injection characteristic for electrolyte solution.

When first opening 111 is sealed with first sealing plate 121, negative electrode terminal 131 and first sealing plate 121 are insulated from each other. In this case, an insulating member such as a resin member may be disposed between negative electrode terminal 131 and first sealing plate 121. It should be noted that negative electrode terminal 131 and first sealing plate 121 may be electrically connected to each other. First sealing plate 121 may serve as the negative electrode terminal.

When second opening 112 is sealed with second sealing plate 122, positive electrode terminal 132 and second sealing plate 122 are insulated from each other. In this case, an insulating member such as a resin member may be disposed between positive electrode terminal 132 and second sealing plate 122. It should be noted that positive electrode terminal 132 and second sealing plate 122 may be electrically connected to each other. Second sealing plate 122 may serve as the positive electrode terminal.

### (Manufacturing Process for Secondary Battery 1)

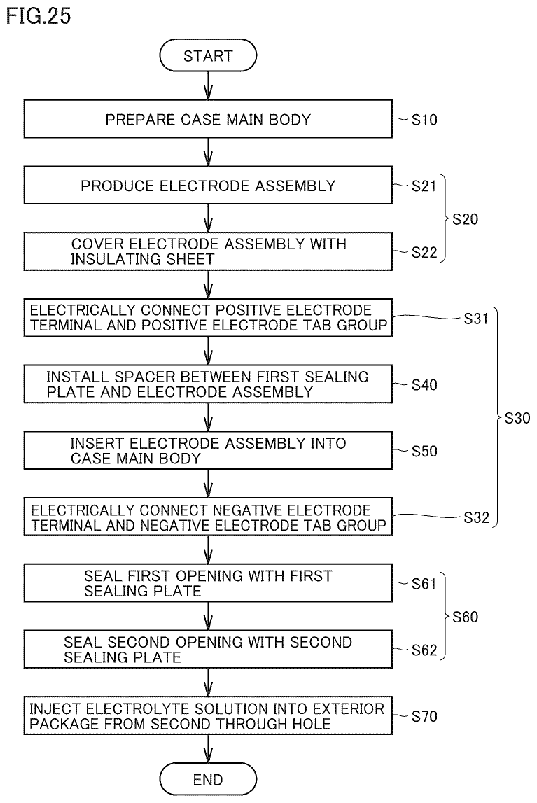

FIG. 25 is a flowchart showing each step of a method of manufacturing secondary battery 1. As shown in FIG. 25, in S10, case main body 110 is prepared. Next, in S20, electrode assembly 200 is produced. In S30, the electrode terminals provided on first sealing plate 121 and second sealing plate 122 are electrically connected to the electrode tab groups of electrode assembly 200. On this occasion, first, negative electrode terminal 131 and negative electrode tab group 210A are electrically connected (S31), then spacer 510 is disposed between first sealing plate 121 on the negative electrode side and electrode assembly 200 (S40), and electrode assembly 200 is further inserted into case main body 110 (S50). On this occasion, positive electrode tab group 220A protrudes to the outside of case main body 110 with respect to second opening 112 of case main body 110. After electrode assembly 200 is inserted into case main body 110, positive electrode terminal 132 and positive electrode tab group 220A are electrically connected to each other (S32).

In the present embodiment, it has been illustratively described that the connecting (S31) of negative electrode terminal 131 and negative electrode tab group 210A, the inserting (S50) of electrode assembly 200, and the connecting (S32) of positive electrode terminal 132 and positive electrode tab group 220A are performed in this order; however, the scope of the present technology is not limited thereto, and the connecting (S32) of positive electrode terminal 132 and positive electrode tab group 220A, the inserting (S50) of electrode assembly 200, and the connecting (S31) of negative electrode terminal 131 and negative electrode tab group 210A may be performed in this order.

After the connecting (S30) of the electrode terminal and the electrode tab group is completed, first opening 111 and second opening 112 are sealed with first sealing plate 121 and second sealing plate 122 (S60). Each of the steps of sealing with first sealing plate 121 and second sealing plate 122 is performed by, for example, laser welding.

The step (S61) of sealing first opening 111 with first sealing plate 121 on the negative electrode side may be performed after the step (S50) of inserting electrode assembly 200 into case main body 110, and the step (S62) of sealing second opening 112 with second sealing plate 122 on the positive electrode side may be performed after the step (S32) of electrically connecting positive electrode terminal 132 and positive electrode tab group 220A.

Therefore, for example, the step (S61) of sealing first opening 111 with first sealing plate 121 may be performed before the step (S32) of electrically connecting positive electrode terminal 132 and positive electrode tab group 220A, and the step (S61) of sealing first opening 111 with first sealing plate 121 may be performed after the step (S62) of sealing second opening 112 with second sealing plate 122. Further, at least parts of the steps (S61, S62) of sealing with first sealing plate 121 and second sealing plate 122 can be performed simultaneously.

Next, a step (S70) of injecting the electrolyte solution into exterior package 100 from second through hole 142 is performed. Second through hole 142 provided on the second sealing plate 122 side with a large space being interposed between electrode assembly 200 and the sealing plate is preferably used as an injection opening for electrolyte solution. On the other hand, since first through hole 141 is provided on the opposite side, first through hole 141 is preferably used as a discharge hole for gas (air, nitrogen, or the like) in exterior package 100. Thus, the injection characteristic for electrolyte solution into exterior package 100 can be improved. It should be noted that the electrolyte solution may be injected from first through hole 141 and the gas may be discharged from second through hole 142.

In the step of injecting the electrolyte solution into exterior package 100, a device for injecting the electrolyte solution is attached into second through hole 142, and a device for discharging the gas is attached into first through hole 141. It should be noted that the device attached into second through hole 142 may also be able to discharge the gas.

After the injection of the electrolyte solution into exterior package 100 is completed, first through hole 141 is sealed with first sealing member 141a (first sealing step), and second through hole 142 is sealed with second sealing member 142a (second sealing step). Either one of the first sealing step and the second sealing step may be performed first. Each of first sealing member 141a and second sealing member 142a is swaged and fixed to case main body 110 by using, for example, a blind rivet or another metal member. Alternatively, each of first sealing member 141a and second sealing member 142a is fixed to case main body 110 by welding.

It should be noted that after one of first through hole 141 and second through hole 142 is sealed, the electrolyte solution may be further injected into exterior package 100 from the other that is not sealed. On this occasion, after one of first through hole 141 and second through hole 142 is sealed, the injection may be performed with the inclination of exterior package 100 being changed such that the other that is not sealed is located at a higher position in the vertical direction.

Here, after one of the first sealing step and the second sealing step is performed, a charging step of charging electrode assembly 200 can be performed, and the other of the first sealing step and the second sealing step can be performed after this charging step. After sealing the through hole on one side, charging is performed, and the generated gas is discharged to the outside of exterior package 100. Then, the through hole on the other side is sealed, with the result that exterior package 100 can be suppressed from being expanded.

### (Summary)

The above-described contents of secondary battery 1 and the method of manufacturing secondary battery 1 according to the present embodiment are summarized as follows.

This secondary battery 1 includes: electrode assembly 200 including negative electrode plate 210 and positive electrode plate 220 having a polarity different from a polarity of negative electrode plate 210; exterior package 100 that accommodates electrode assembly 200 and the electrolyte solution; negative electrode terminal 131 electrically connected to negative electrode plate 210 and provided at exterior package 100; and positive electrode terminal 132 electrically connected to positive electrode plate 220 and provided at exterior package 100; wherein exterior package 100 includes first sealing plate 121 and second sealing plate 122 disposed to face each other, first sealing plate 121 is provided with first through hole 141 and first sealing member 141a that seals first through hole 141, second sealing plate 122 is provided with second through hole 142 and second sealing member 142a that seals second through hole 142, first sealing member 141a is different from negative electrode terminal 131 and positive electrode terminal 132, and second sealing member 142a is different from negative electrode terminal 131 and positive electrode terminal 132. According to this secondary battery 1, since secondary battery 1 is provided with first through hole 141 and second through hole 142, it is possible to provide secondary battery 1 that allows for improved injection characteristic and that can be stably manufactured.

In secondary battery 1 according to an example, exterior package 100 includes case main body 110 provided with first opening 111 at one end of case main body 110 and second opening 112 at the other end of case main body 110, first sealing plate 121 that seals first opening 111, and second sealing plate 122 that seals second opening 112, first sealing plate 121 is provided with negative electrode terminal 131, second sealing plate 122 is provided with positive electrode terminal 132, electrode assembly 200 includes negative electrode tab group 210A located at one end portion of electrode assembly 200 and including the plurality of negative electrode tabs 210B electrically connected to negative electrode plate 210, and positive electrode tab group 220A located at the other end portion of electrode assembly 200 and including the plurality of positive electrode tabs 220B electrically connected to positive electrode plate 220, negative electrode tab group 210A is electrically connected to negative electrode terminal 131, and positive electrode tab group 220A is electrically connected to positive electrode terminal 132.

In secondary battery 1 according to an example, negative electrode tab group 210A is folded and joined to negative electrode terminal 131 or negative electrode current collector 310 electrically connected to negative electrode terminal 131, and positive electrode tab group 220A is folded and joined to positive electrode terminal 132 or positive electrode current collector 320 electrically connected to positive electrode terminal 132.

In secondary battery 1 according to an example, in the long-side direction (Z direction) of first sealing plate 121, first through hole 141 is displaced to the side in the first direction (Z direction) with respect to the center of first sealing plate 121, and in the long-side direction (Z direction) of second sealing plate 122, second through hole 142 is displaced to the side in the first direction (Z direction) with respect to the center of second sealing plate 122. For example, when injecting the electrolyte solution into exterior package 100 with the direction that connects first sealing plate 121 and second sealing plate 122 being substantially horizontal, first through hole 141 and second through hole 142 are formed at positions close to the upper surface thereof, thereby facilitating the injection.

The method of manufacturing this secondary battery 1 configured as described above includes: injecting the electrolyte solution into exterior package 100 from at least one of first through hole 141 and second through hole 142; sealing first through hole 141 with first sealing member 141a; and sealing second through hole 142 with second sealing member 142a.

In the method of manufacturing secondary battery 1 according to an example, in the injecting, the electrolyte solution is injected into exterior package 100 from one of first through hole 141 and second through hole 142 and the gas in exterior package 100 is discharged from the other of first through hole 141 and second through hole 142 to the outside of exterior package 100. Thus, the electrolyte solution can be more efficiently injected by naturally discharging the gas.

In the method of manufacturing secondary battery 1 according to an example, positive electrode plate 220 has positive electrode active material layer 222, and in the direction that connects first sealing plate 121 and second sealing plate 122, the relation of D2>D1 is satisfied, where D1 represents the distance between first sealing plate 121 and the end portion of positive electrode active material layer 222 on the first sealing plate 121 side, and D2 represents the distance between second sealing plate 122 and the end portion of positive electrode active material layer 222 on the second sealing plate 122 side, and the injecting includes injecting the electrolyte solution into exterior package 100 from second through hole 142. Thus, the electrolyte solution can be injected further efficiently.

### (Functions and Effects)

According to secondary battery 1 and the method of manufacturing secondary battery 1 in the present embodiment, secondary battery 1 can be efficiently manufactured and the injection characteristic can be improved. For example, when secondary battery 1 is placed with the long-side direction of exterior package 100 being horizontal, the injection characteristic for electrolyte solution into exterior package 100 can be increased. As a result, secondary battery 1 can be manufactured more efficiently and stably.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising:
an electrode assembly including a first electrode and a second electrode having a polarity different from a polarity of the first electrode;
an exterior package that accommodates the electrode assembly and an electrolyte solution;
a first electrode terminal electrically connected to the first electrode and provided at the exterior package; and
a second electrode terminal electrically connected to the second electrode and provided at the exterior package, wherein
the exterior package includes a first wall and a second wall disposed to face each other,
the first wall is provided with a first through hole and a first sealing member that seals the first through hole,
the second wall is provided with a second through hole and a second sealing member that seals the second through hole,
the first sealing member is different from the first electrode terminal and the second electrode terminal, and
the second sealing member is different from the first electrode terminal and the second electrode terminal.

2. The secondary battery according to claim 1, wherein
the exterior package includes
a case main body provided with a first opening at one end portion of the case main body and a second opening at the other end portion of the case main body,
a first sealing plate that seals the first opening, and
a second sealing plate that seals the second opening,
the first wall is the first sealing plate,
the second wall is the second sealing plate,
the first sealing plate is provided with the first electrode terminal,
the second sealing plate is provided with the second electrode terminal,
the electrode assembly includes
a first electrode tab group located at one end portion of the electrode assembly and including a plurality of first electrode tabs electrically connected to the first electrode, and
a second electrode tab group located at the other end portion of the electrode assembly and including a plurality of second electrode tabs electrically connected to the second electrode,
the first electrode tab group is electrically connected to the first electrode terminal, and
the second electrode tab group is electrically connected to the second electrode terminal.

3. The secondary battery according to claim 2, wherein
the first electrode tab group is folded and joined to the first electrode terminal or a first electrode current collector member electrically connected to the first electrode terminal, and
the second electrode tab group is folded and joined to the second electrode terminal or a second electrode current collector member electrically connected to the second electrode terminal.

4. The secondary battery according to claim 1, wherein
in a long-side direction of the first wall, the first through hole is displaced to a side in a first direction with respect to a center of the first wall, and
in a long-side direction of the second wall, the second through hole is displaced to a side in the first direction with respect to a center of the second wall.

5. A method of manufacturing a secondary battery, the secondary battery comprising:
an electrode assembly including a first electrode and a second electrode having a polarity different from a polarity of the first electrode;
an exterior package that accommodates the electrode assembly and an electrolyte solution;
a first electrode terminal electrically connected to the first electrode and provided at the exterior package; and
a second electrode terminal electrically connected to the second electrode and provided at the exterior package, wherein
the exterior package includes a first wall and a second wall disposed to face each other,
the first wall is provided with a first through hole and a first sealing member that seals the first through hole,
the second wall is provided with a second through hole and a second sealing member that seals the second through hole,
the first sealing member is different from the first electrode terminal and the second electrode terminal, and
the second sealing member is different from the first electrode terminal and the second electrode terminal,
the method comprising:
injecting an electrolyte solution into the exterior package from at least one of the first through hole and the second through hole;
sealing the first through hole with the first sealing member; and
sealing the second through hole with the second sealing member.

6. The method of manufacturing the secondary battery according to claim 5, wherein
in the injecting, the electrolyte solution is injected into the exterior package from one of the first through hole and the second through hole and a gas in the exterior package is discharged from the other of the first through hole and the second through hole to outside of the exterior package.

7. The method of manufacturing the secondary battery according to claim 5, wherein
the second electrode has a second electrode active material layer,
in a direction that connects the first wall and the second wall, a relation of D2>D1 is satisfied, where
D1 represents a distance between the first wall and an end portion of the second electrode active material layer on the first wall side, and
D2 represents a distance between the second wall and an end portion of the second electrode active material layer on the second wall side, and
the injecting includes injecting the electrolyte solution into the exterior package from the second through hole.
